(19) United States
(12) Patent Application Publication
(10) Pub. No.: US 2019/0073395 A1
(43) Pub. Date: Mar. 7, 2019

(54) METAD SEARCH PROCESS FOR LARGE SCALE STORAGE SYSTEM

(71) Applicant: SCALITY, S.A., Paris (FR)

(72) Inventors: Giorgio REGNI, Albany (US); Lauren SPIEGEL, San Francisco (US); Vianney RANCUREL, San Francisco (US)

(21) Appl. No.: 16/184,904

(22) Filed: Nov. 8, 2018

Related U.S. Application Data
(63) Continuation of application No. 15/616,848, filed on Jun. 7, 2017, now abandoned.

(51) Int. Cl. G06F 17/30; H04L 29/06

(52) U.S. Cl. CPC G06F 17/30463; H04L 69/04; G06F 17/30864

(57) ABSTRACT

A method is described. The method includes receiving a request to search meta data for objects stored within a large scale object storage system. The request identifies a looked for value of the meta data. The objects belong to a same bucket used to identify a subset of objects stored by the large scale object storage system. The method includes forwarding the request to a meta data database system that contains pages listing all objects within the bucket and the associated meta data for each of the objects within the bucket. The method includes forwarding the pages from the meta data database system over a network to a high performance computing resource that concurrently processes multiple ones of the pages to identify matching ones of the objects whose meta data matches the looked for value.

### RELATED CASES

This application is a continuation of and claims the benefit of U.S. patent application Ser. No. 15/616,848, entitled, “METADATA SEARCH FOR LARGE SCALE STORAGE SYSTEM”, filed Jun. 7, 2017, which is incorporated by reference in its entirety.

### FIELD OF INVENTION

The field of invention pertains generally to the computing sciences, and, more specifically, to a metadata search process for a large scale storage system.

### BACKGROUND

In the case of large scale storage systems (such as storage systems that store petabytes of information), searching for specific stored items based on attributes (meta data) associated with them presents significant challenges. Specifically, the resources needed to perform the search may naturally tend to scale with the amount of data items that are stored in the large scale storage system which, in turn, greatly complicates the functionality of the overall storage system.

### FIGURES

A better understanding of the present invention can be obtained from the following detailed description in conjunction with the following drawings, in which:

FIG. 1a shows a prior art PUT operation;

FIG. 1b shows a prior art GET operation;

FIG. 2 shows pages for a bucket of objects within a meta data cluster;

FIG. 3a shows a first meta data search process;

FIG. 3b shows a second meta data search process;

FIG. 4 shows an exemplary object storage system;

FIG. 5 shows an exemplary meta data database system;

FIG. 6 shows an exemplary computer

### DETAILED DESCRIPTION

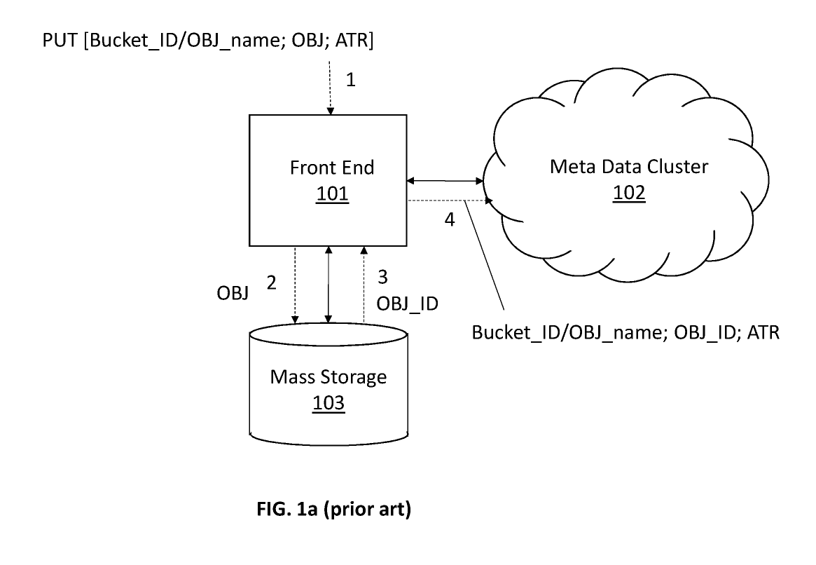

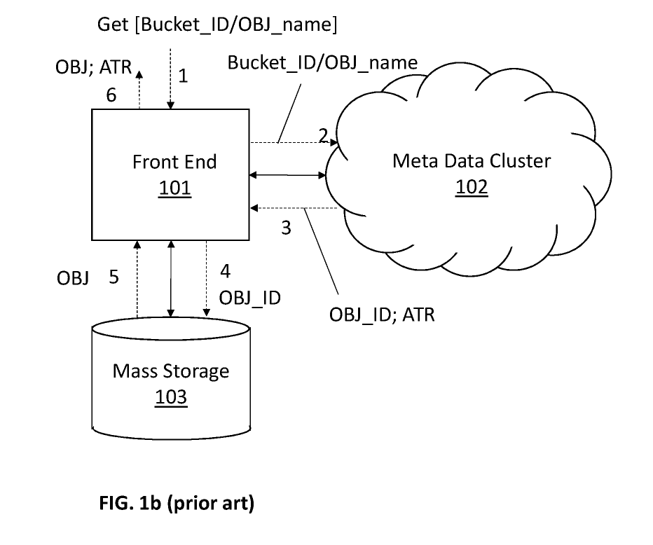

FIG. 1a shows a prior art PUT command for an, e.g., large cloud based storage system that tracks attributes for the data items that it stores. The attributes correspond to meta data on a stored item and typically include some kind of descriptive and/or characterizing information about the stored item. Examples include, to name a few, how large the stored data item is, when the item was created, when the item was last changed, when the item was last accessed, information describing and/or characterizing the substantive content that is stored by the item, a security level of the item, an owner or the item, etc.

Here, front end 101 corresponds to a high-end computer or networked arrangement of high end computer servers that handle, e.g., large numbers of client requests that are received from a network such as the Internet and/or a large private network. As such, the front end 101 may be implemented as one or more computers that collectively include a plurality of processors coupled to respective main memory and computer readable storage media, where, the computer readable storage media collectively contains program code that when processed by the plurality of processors from their respective main memory causes the meta data search method described herein to be performed.

As observed in FIG. 1a, the front end 101 receives a PUT command 1 having a command syntax that specifies the item being placed into the storage system by name (OBJ_name). The mass storage system 103 corresponds to an object storage system that puts/gets items to/from mass storage 103 based on an identifier (also referred to as an object ID) of the item (which is referred to as an object) to be written/read to/from mass storage 103. Identifying data objects in mass storage 103 by an by an object ID is unlike traditional “file” based mass storage systems that can only identify a particular item by specifying a path through a directory of the file system.

In response to its receipt 1 of the PUT command, the front end 101 presents the object to be stored 2 to the mass storage system 103, which also returns 3 an object ID for the object. Again, the client/user of the cloud storage system may refer to the object using its own naming convention (“name”), whereas, internally within the cloud storage service and within the mass storage system 103 specifically, the same object is identified by an object ID (which may be, e.g., a numeric string). Allowing users to name objects according to their own preferred naming convention allows for easier user integration with the cloud storage service while internally identifying objects with unique object IDs provides for, e.g., easier management and/or scalability of the mass storage system 103.

As observed in the syntax of the PUT command, the object name is preceded by a bucket identifier (Bucket_ID) that, e.g., associates the name of the object being PUT with a particular entity or owner that the object is associated with. As a basic example, assume the cloud storage service has a number of different corporate clients and the Bucket_ID corresponds to the identifier of the particular corporation that is submitting the PUT command (i.e., each of the different corporate customers has a unique, different Bucket_ID). More generally, a bucket corresponds to some partition or subset of the objects that are stored in the mass storage system 103 (e.g., a particular user's objects corresponds to the bucket/subset of objects belonging to that user). Here, associating each object with its appropriate bucket allows for, e.g., different types of service for different customers (e.g., different buckets may keep different attribute/metadata content, have different allocated storage amounts, different guaranteed access times, etc.). Associating each object name with a bucket allows for different buckets/customers to name their objects with same names.

In response to the return 3 of the object_ID for the object being put, the front end 101 stores 4 the object's meta data into a meta data cluster 102. As observed in FIG. 1a, the meta data that is stored in the meta data cluster 102 for the object may include the bucket_ID for the object; the name of the object as identified by the user/customer (OBJ_name); the object_ID that was returned for the object by the mass storage system 103 (OBJ_ID); and any/all of the attributes (ATR) that were submitted with the object by the PUT command and any additional attributes that are to be associated with the object (e.g., as created by the cloud storage service).

FIG. 1b shows a prior art GET command for the same object that was PUT into storage by the PUT command sequence of FIG. 1a. As observed in FIG. 1b, the GET command 1 syntax identifies the object to be fetched by bucket ID and object name. In response to its receipt of the GET command, the front end 101 provides the Bucket_ID and object name to the meta data cluster 102 which uses them as look up parameters to fetch 3 the object ID and attributes for the object. The front end 101 provides the returned object_ID to the mass storage system 103 which provides 5 the object. The front end 101 combines the attributes (ATR) that were returned by the meta data cluster 102 with the returned object to provide a complete response 6 containing both the requested object and its attributes to the requesting customer.

According to the procedures of the prior art PUT and GET commands of FIGS. 1a and 1b, note that the attributes that are associated with an object (such as attributes that were submitted in a PUT command for the object and/or any attributes created by the cloud storage service) are stored in the meta data cluster 102, whereas, the object itself is stored in the mass storage system 103. Notably, users/customers often desire to search their meta data, e.g., as a pre-process to identifying objects having certain qualities that will next be fetched from mass storage 103.

As an example, recall that the meta data may contain some description of the content of the object. If a user desires to fetch objects having certain content, they may seek to search the meta data of their objects to identify those objects that should be fetched. The searching of the meta data may be more economical than searching through all the stored objects because, e.g., typically, the meta data for an object has a much smaller data size than the object itself and reading all the objects from mass storage to search through all of them would be prohibitive.

In various approaches the attributes that are associated with an object include a description of the object's content for the purpose of searching the meta data to identify objects having specific content. For example, an object may store a large number of different values. The attributes for the object may specify the minimum and the maximum of these values. If the user/customer desires to fetch all of its objects having a particular value, it can search through the meta data of all of its objects and flag those objects whose meta data indicates a stored value range that the searched for value falls within. A wealth of other, different kinds of applications are possible. The above example is simply one example of why/how users may use attributes that are associated with their objects.

A problem however is the meta data cluster 102. Ideally, the meta data cluster 102 operates as a simple look-up tool that returns an object ID and meta data for an object based on a provided bucket and name of the object (likewise, ideally, the meta data cluster merely uploads new object information by storing an object's bucket ID, name ID and attributes in association with the object's object ID. Complicating the meta data cluster to perform search functions can significantly impact the performance, scalability and/or cost of the meta data cluster 102 particularly in the case of cloud based storage systems whose mass storage system 103 may store billions or objects, petabytes of data or even higher storage measurement amounts. The massive scale of the mass storage system 103, in turn, corresponds to a large and sophisticated search function that needs to be built into the meta data cluster 102 that detrimentally complicates the design and function of the meta data cluster 102.

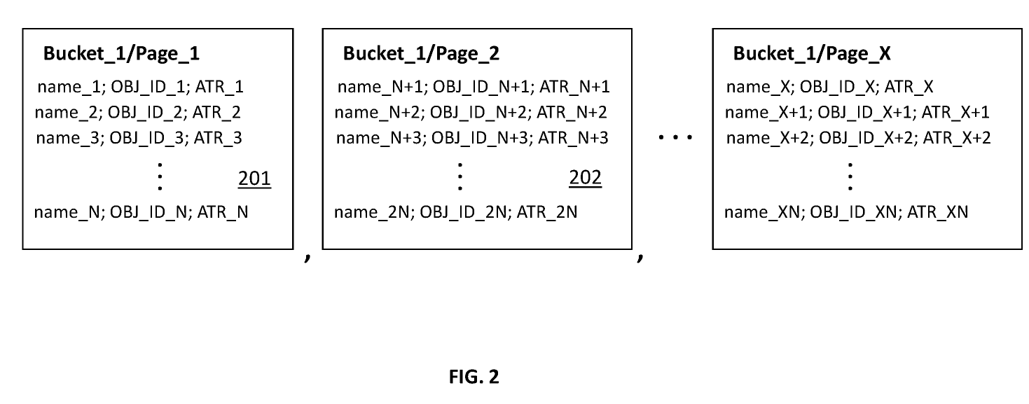

FIG. 2 presents a high level depiction of the manner in which meta data may be physically stored in the meta data cluster 102 for a particular bucket. As observed in FIG. 2, the meta data for the objects stored in a same bucket are organized onto pages (e.g., bodies of textual content) where each page lists the respective meta data for different objects stored in the bucket (with each page listing the meta data for different objects). As observed in FIG. 2, for a bucket that stores X*N objects, a first page 201 contains the meta data for the first N objects stored in the bucket (objects 1 through N), the second page 202 contains the meta data for the next N objects stored in the bucket (objects N+1 through 2N) and the Xth page contains the meta data for the Xth N objects (objects X through XN). That is, each page has the capacity to list the meta data for N objects, and, with the bucket having X*N objects, the bucket's meta data is physically implemented as the storage of X pages.

Here, e.g., if the listing of the objects on the pages and across pages is organized according to some kind of sequence order of the object names, “flat” search tree structures are readily obtained. That is, the stored page structure of FIG. 2 allows for fast access to the meta data and/or object ID for any particular object based on that object's bucket ID and name ID. Here, the bucket ID easily resolves to one of the X pages within the meta data cluster and the name ID can be readily used to identify the appropriate one of these X pages. For example, if each page is characterized according to the range of name IDs that it keeps the meta data of (e.g., name_1 through name_N for Page_1 201), an access based on a specific name can easily be directed to the page whose range of names the specific name falls within. Once the correct page is identified it is read from the meta data cluster database and the meta data content for the particular object name is extracted.

By contrast, extending this kind of streamlined access efficiency based on the attributes (e.g., to provide search capability of attribute content) greatly complicates the design of the meta data cluster given that the size of the attribute data may be large as compared to the name size, and/or, the attribute values may entertain a wealth of different and/or varied values. Here, for instance, if the attribute field for each object's meta data contains ten different attributes, ten additional sets of X pages beyond the name ranked pages of FIG. 2 may need to be kept by the meta data cluster to provide search capability for each of the ten different attributes (each set would need to rank entries for all objects in the bucket based on the particular value of one of the attributes which in all likelihood completely rearranges page content as compared to another ranking based on another attribute). In this case, the storage capacity of the meta data cluster would need a 10× expansion.

An interesting observation, however, is that each page typically does not correspond to a tremendous amount of information (e.g., 10 MB or less per page), while, at the same time, each page may contain entries for large numbers of objects (e.g., approximately 1 million objects). Thus, e.g., a bucket having a billion objects need only have 1000 pages in the meta data cluster. Another observation is that “big data” computing systems, which are generally characterized as higher performance computing centers having large numbers of worker nodes that can be dispatched to operate on incoming input data, are specialized at processing such pages.

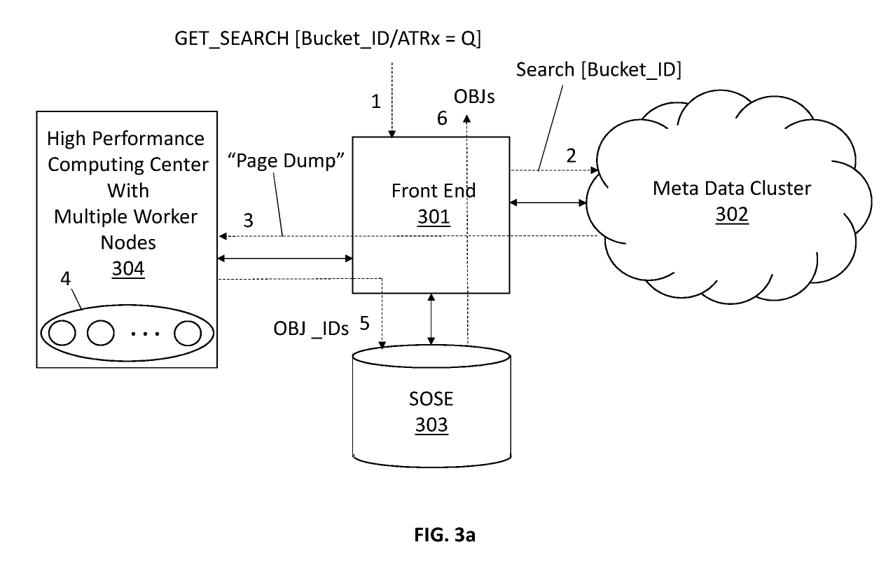

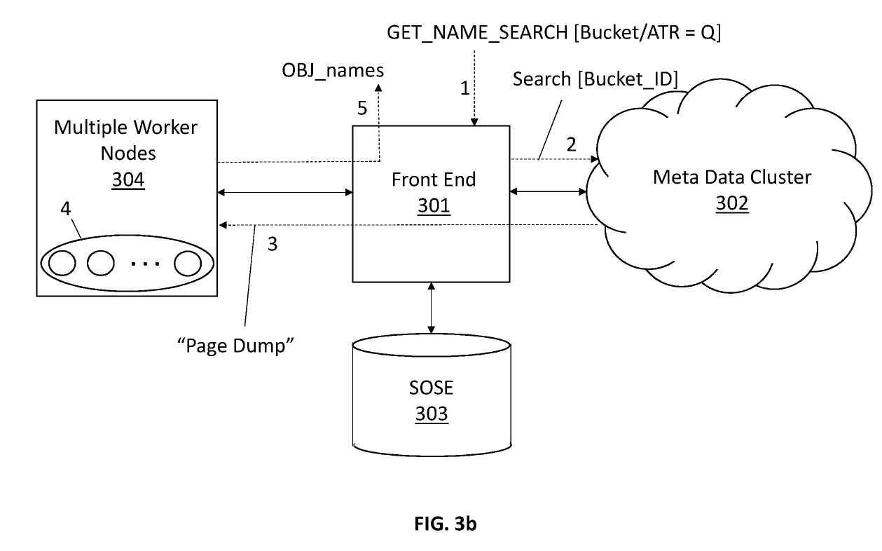

As such, FIG. 3a shows an efficient cloud storage system architecture that performs meta data searches by “dumping” the pages for the bucket that the search is being performed for from the meta data cluster to a high performance computing center 304.

FIG. 3a shows a first search based GET operation in which a user/customer provides 1 a GET operation for objects that match a specific search criteria (GET_SEARCH). As shown in the example of FIG. 3a, the search criteria is that a specific attribute ATR_{X} equals a specific value Q. The front end 301 informs 2 the meta data cluster 302 that a search request has been made for the particular bucket (by specifying both a search and the Bucket_ID). In response, the meta data cluster 302 “dumps” 3 all of the pages for the bucket (e.g., all X pages of FIG. 2 for the bucket of FIG. 2) as its return.

The dumped pages are forwarded to a high performance computing center 304 that dispatches its worker nodes to the incoming pages (e.g., a percentage of the pages is processed per worker node at any instant of time). Different worker nodes, e.g., concurrently operate on different pages and determine the search results for the particular page(s) they process. Here, for each entry on a page that a worker node is processing, the worker nodes analyzes the particular attribute that is targeted by the search request and identifies those entries whose particular attribute matches the search query. The front end 301 also forwards the search query to the high performance computing center 304 which is not shown in FIG. 3a for illustrative ease. In various embodiments, the front end also 301 provides an inventory of all of the pages to the high performance computing center 304 (which provides the size of each page). Accordingly, the master executor of the high performance computing center's search process can use this inventory to divide up the work of retrieving, forwarding and/or parsing the actual pages to its workers.

Eventually all pages are processed by the high performance computing center 304, the search results from all pages are combined and the corresponding object IDs of the matching entries are forwarded 5 to the mass storage system 303. The mass storage system, in response, 303 returns the objects identified by the object IDs that yielded from the search process and the front end 301 provides 6 these returned objects to the user/customer that submitted the original GET_SEARCH operation.

In various embodiments of either of the processes of FIGS. 3a and 3b, compression may be applied to the dumped pages, e.g., prior to being emitted by the meta data cluster 302 and/or by the front end 301 to reduce their respective sizes during transport of the pages from the meta data cluster 302 to the multiple worker nodes 304. Reducing page size for the transportation from the meta data cluster to the high performance computing center 304 should improve the transport latency time between the two. Here, the emission point of the pages from the meta data cluster 302 and the entrance point of the pages at the high performance computing center 304 may be separated by large distances requiring a wide area network (WAN) to be disposed between them. The same may be true for the connections between the front end 301 and any of the meta data cluster 302, mass storage 303 and high performance computing center 304.

In alternative or combined embodiments, the pages are stored in the meta data cluster in a compressed format. According to a nominal page access, the page is decompressed by the meta data cluster or the front end so that its information can be processed. However, for either of the search processes of FIGS. 3a and 3b, the pages are not decompressed by the meta data cluster or front end so that they retain their smaller data footprint size for transportion over one or more networks from the meta data cluster to the high performance computing center.

Note that the dumped pages from the meta data cluster 302 need not pass through the front end 301 on their way to the high performance computing center 304 (they may be passed directly from one to the other). Regardless if the pages are specially compressed for transportation to the data center for searching or are nominally compressed as stored in the meta data cluster and forwarded to the center in the compressed format, the high end computing center 304 may decompress the pages after their receipt to reconstitute the meta data that is to be searched over.

Note that the functionality performed by the front end 301 described above for the processes of FIGS. 3a and 3b may be implemented with software and/or hardware of the computers that the front end 301 is composed of.

FIG. 3b shows a similar process except that the specific command from the user/customer GET_NAME_SEARCH does not request the actual objects that match the search query, but rather, only requests their names. As such, processes 1, 2, 3 and 4 are the same as described above (except for the particular command from the user/customer). When search results from the processing of all pages by the worker nodes 304 is complete, the worker nodes 304 provide the names of the matching objects rather than their object_IDs. The front end 301 provides these names directly 5 to the requesting customer (no matching objects are provided).

As alluded to above, the high performance computing center may be implemented, e.g., as a networked arrangement of high performance computing systems (e.g., high performance servers). Each high performance computing system may include one or more multi-threaded central processing units (CPUs). As is known in the art, multi-threadedness may be realized in hardware and/or in software. In the case of hardware multi-threading, typically, the CPU dedicates local register space (e.g., of an instruction execution pipeline) to a particular thread. If multiple such allocations exist in the register space, the CPU/pipeline is able to concurrently execute instruction streams from different software programs. In the case of software multi-threading, typically, lower level software such as an operating system instance and/or virtual machine monitor is allocated hardware resources (e.g., a CPU, a processing core within a CPU, one or more hardware threads of a CPU or CPU core). The lower level software then proceeds to control, dispatches or otherwise organize the execution of different software program instances on the hardware resources it has been allocated.

High performance computing systems typically include many CPUs, associated processing cores and hardware threads in combination with lower level software that can implement software level multi-threading. Typically, a “job”, such as the search request described above with respect to FIGS. 3a and/or 3b is presented to the high performance computing center. Control software and/or hardware of the high performance computing center allocates various hardware and/or software threads to the job. In one approach, a virtual machine monitor (VMM) is allocated one or more hardware threads and executes multiple operating system (OS) instances and/or virtual machines (VMs), e.g., as software threads. As such, in various implementations, each of the aforementioned worker nodes 304 can be viewed as a virtual machine that has been allocated by one or more VMMs to execute its own page search process software program (instruction stream).

Typically, a common characteristic of a high performance data center is that it contains a “pool” of available hardware and/or software threads and/or VMs. Multiple ones of such threads/VMs are dispatched to an incoming job so that the job can be processed with multiple concurrent threads/VMs. The more threads/VMs that can be dispatched to the job the more parallelism that can be leveraged to shorten the overall job process time. For example, using the example of a search process where the corresponding bucket consists of 1,000 pages of meta data, if the high performance data center is able to dispatch 100 threads/VMs to the search process, each thread/VM need only process 10 pages to complete the entire search (the 1,000 pages are distributed to the 100 threads/VMs by the high performance data center).

The high performance data center may be implemented as a private “big data” computation center (e.g., Apache Spark™ and/or Apache Hadoop™ framework based) and/or one or more publicly available high performance data centers that are available through the Internet such as an Amazon Web Services cloud computing platform (e.g., Amazon EC2 or AWS Batch), a Microsoft cloud computing platform (e.g., Azure™), and/or a Google cloud computing platform (e.g., Google Compute Engine). As will be described in more detail below, both the meta data cluster 102 and the mass storage 103 may also be wholly or partially implemented with a publicly available (key-value) database cloud service platform (for the meta data cluster) and publicly available storage cloud service platform (for the mass storage), in which case, the front end 101 will comprise multiple interfaces to multiple cloud based service platforms.

Adding to the efficiency of the search process is that the pages that are dumped from the meta data cluster to the high performance computing center are composed of a structured data and/or text file that is easily processed and/or parsed by the instruction stream of a search process thread/VM in order to isolate the searched for meta data field for each entry on a page being processed. Examples of such pages includes pages written as JavaScript Open Notation (JSON) pages, eXtensible Markup Language (XML) pages and/or YAML Ain't Markup Language (YAML) pages among possible others.

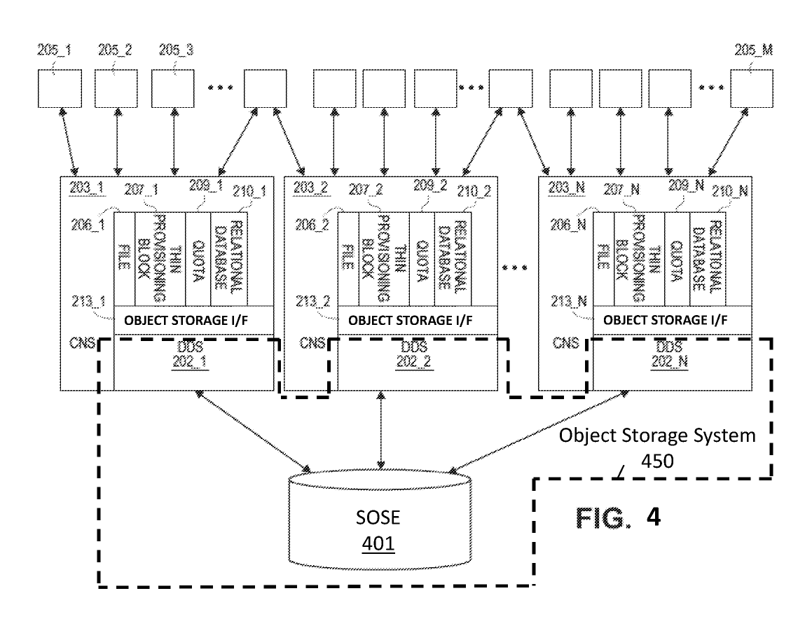

The mass storage system 303 described above may be implemented, as stated above, an object storage system. FIG. 4 shows an embodiment of an architecture for an object storage system. As observed in FIG. 4, the architecture includes a set of storage entities (SOSE) 401, a distributed database management system (DDS) 202 (implemented with separate DDS instances 202_1 through 202_N) and a connectors node system (CNS) 203 (implemented with separate CNS instances 203_1 through 203_N).

At a high level perspective, the SOSE 401 can be viewed as the physical storage resource of the system. In various implementations the SOSE 401 includes a combination of different types of storage entities (e.g., servers, ipdrives, object storage systems, cloud storage services, etc.). Various distributed storage systems of the SOSE system may be separated by any of a local area network (LAN), metropolitan area network (MAN) and/or a wide area network (WAN). In various embodiments, the DDS instances and the SOSE combined behave as an over-arching object storage system 400 in which items that are physically stored in the SOSE 401 are identified with unique object IDs provided by the DDS. That is a requester/user that seeks to access an object in the object store 450, provides an object ID to a DDS instance, which, in turn, causes the CNS to access that object in the SOSE.

From the perspective of a requester/user that interfaces to the object store 450 through the DDS, objects are units of fundamental storage in the object store. Each object is assigned its own unique (e.g., random) identifier that uniquely identifies its corresponding object. As described above, this particular type of access is distinguishing from other types of storage systems such as file systems (whose fundamental unit of storage, a “file”, is identified with a directory path) and block storage systems (whose fundamental unit of storage, “a block” is identified with a numerically restrictive offset). In various embodiments, the SOSE 401 includes technology described in U.S. application Ser. No. 12/640,373 filed on Dec. 17, 2009 entitled “Multipurpose Storage System Based Upon A Distributed Hashing Mechanism With Transactional Support and Failover Capability” and issued as U.S. Pat. No. 8,429,444 which is hereby incorporated by reference in its entirety.

The DDS 402 therefore can be viewed as a distributed management layer above the SOSE 401 that provides an object storage interface 213 to the SOSE. Additional interfaces 206, 207, 210 may be provided on top of the object storage interface 213 that permit the object storage system formed by the DDS and the SOSE to be used as file directory, block based storage system or relational database (or the object storage interface 213 can be accessed directly to receive object storage behavior). A quota policing function 209 may also be integrated with the interfaces 206, 207, 210, 213 to, e.g., prevent users from storing more data than their allocated amount in the DDS/SOSE storage system. In various embodiments, the DDS 202 implements a distributed consensus algorithm and load balancing algorithms to effect widely scalable storage access to/from the SOSE storage resources 401.

With the DDS 202 and the CNS 203 a wide range of different storage system interfaces to end-users 205_1 though 205_M. Here, an “end-user” or “user” or “requestor” is any entity that makes use of the DDS/SOSE object storage system 450. Examples include an application software instance, an application software process, a client computer instantiated with any one or more of these software instances/processes, an organization such as a corporation, etc. In the context of the search process described at length above, the front end 301 may be designed to concurrently provide requests to one or more CNS nodes and therefore may represent multiple users 205 as depicted in FIG. 4.

With direct access to the object storage interface 213, the CNS 203 is able to provide various object store connectors/interfaces to end-users (e.g., Cloud Data Management Interfaces (CDMI), Simple Storage System (S3), etc.). With access to the file directory interface 206 provided by the DDS 202, the CNS 203 is able to provide any directory file system connector/interface to end-users (e.g., Network File System (NFS), Common Internet File System (CIFS), File System in User Space (FUSE), etc.). Likewise, with access to the block storage interface 207 provided by the DDS 202, the CNS 203 is able to provide any block storage system connector/interface to end users (e.g., iSCSI, FC). Again, any/all of these different storage solutions may simultaneously be implemented on the DDS/SOSE object storage system.

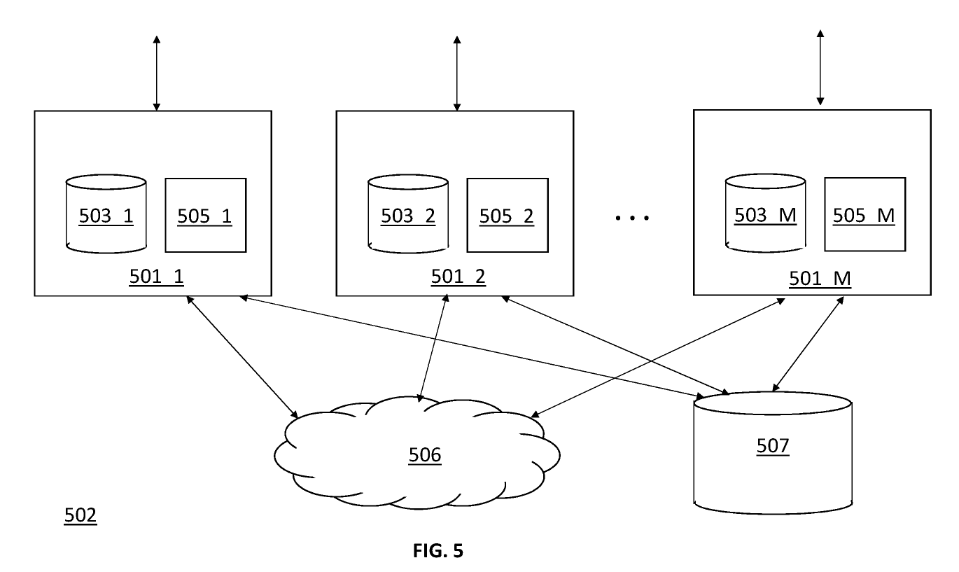

FIG. 5 shows an embodiment of a meta data cluster 502 which includes a distributed cluster of meta data nodes 501_1 through 501_M. Each meta data node may be implemented, e.g., on a server computer and/or as software that executes on one or more server computers. According to the embodiment of FIG. 5, the meta data cluster 502 is able to handle concurrent meta data requests across the plurality of meta data nodes 501_1 through 501_M. Each meta data node 501_1 through 501_M is coupled to a main mass storage entity 507 that contains the full state of the meta data cluster. The meta data cluster nodes are responsible for responding to requests to the meta data in mass storage 507 while keeping the content of mass storage 507 consistent.

Meta data requests may be passive in that no change to the state of the meta data cluster within storage 507 is performed as a consequence of the request. An example is a simple request for the object ID of an object in response to a Bucket_ID and Name_ID without any update to the attribute information (e.g., there is no last time accessed attribute).

Other types of meta data requests, however, may involve some change to the state of the information that is contained within the meta data storage 507. Examples include a PUT command that enters a new bucket_ID, object_name, object_ID and attributes for a new object that is entered into the mass storage 303 of the overall storage service. Another example is a DELETE command that deletes an entry for an object in the meta data cluster in response to the corresponding object being deleted from mass storage 303. Another example is a GET command in which a bucket_ID and object name are provided to the meta data cluster and a corresponding object_ID and attributes are returned in response, where, subsequently, the attributes are updated with new information in meta data storage 507 (e.g., last time accessed, a new description of the object's content if the object's content changes, etc.). Here, the meta data cluster writes the new attributes over the old attributes within storage 507 for the corresponding object.

In an embodiment, any of the meta data nodes 501_1 can be used to access the meta data in storage 507 for any object that is stored in the mass storage 303 of the overall service. The ability to direct meta data requests for any object to any of the meta data nodes 501_1 through 501_M provides reliability in the overall meta data cluster 502. That is, if any particular meta data node fails, its live requests can be directed to any other of the meta data nodes without the requestor noticing.

As observed in FIG. 5, the meta data nodes 501_1 through 501_M within the meta data cluster 502 are each coupled to a network 506 to implement a distributed synchronization algorithm (e.g., Raft, PAXOS or like algorithm) in order to handle requests that involve a change of state to the meta data content within storage 507 (e.g., addition of new entry, deletion of existing entry, update to attribute data, etc.). Distributed synchronization algorithms are typically designed to guarantee progression of information if an agreement/consensus is reached among the majority of the participants. That is, if a quorum of the meta data nodes 501_1 through 501_M agree to a change in the meta data content within storage 507, the change should eventually reach all of the meta data nodes 501_1 through 501_M.

In an embodiment, the distributed synchronization algorithm used within the meta data cluster 502 considers all but one of the meta data nodes 501_1 through 501_M to be an “acceptor” node and the remaining non acceptor node to be a “proposer” node. For the sake of example, assume meta data node 501_1 is deemed to be the proposer node. Even though meta data node 501_1 may be nominated as the proposer and therefore perform proposer functions, it may also continue to operate as an acceptor node. As such the acceptor nodes include meta data nodes 501_1 through 501_M.

According to one embodiment, initially a request to change meta data for a particular entry is received by one of the meta data nodes 501_1 through 501_M (assume it is meta data node 501_M). The meta data node 501_M that receives the state change request then forwards the request to the proposer node 501_1. In response to receipt of the state changing request, the proposer node 501_1 broadcasts the proposed change to all of the meta data nodes 501_1 through 501_M.

In an embodiment, each acceptor node 501_1 through 501_M has its own associated persisted storage 503_1 through 503_M (e.g., a non volatile data store) that keeps state information on proposed and granted state change requests to meta data storage 507. Each acceptor node 501_1 through 501_M then individually votes on whether or not the proposed change is acceptable based on the information within its local persisted store 503. Here, in an embodiment, each acceptor node votes “yes” for the proposed meta data change if there is no record of a competing approved state change request (that is, there is no approved state change request for the same entry or same attribute within a particular entry that the proposed request seeks to change). By contrast, if an acceptor node identifies a competing approved state change request within its local store it will vote “no” for the proposed state change.

Here, again, recall that the overall storage service may implement one or more extremely large mass storage buckets that each may receive a high rate of requests from many different sources and/or geographical locations. As such, the meta data cluster itself may receive a high rate of requests from many different sources and/or source locations and is therefore distributed as represented by the meta data nodes 501_1 through 501_M.

The votes are reported to and tabulated by the proposer node 501_1. The proposer node 501_1 will decide to implement the lock so long as a quorum of the acceptor nodes 501_1 through 501_M voted for acceptance of the state change (“a quorum is reached”). A quorum may exist, for example, if a majority but less than all of the acceptor nodes 501_1 through 501_M voted “yes” for the state change. Use of a quorum is particularly well suited for extremely large systems having, e.g., large numbers of acceptor nodes (M is large) spread over a wide geographic area because under such circumstances it is not uncommon for one or a few acceptors: 1) to be effectively unavailable to participate in the vote (e.g., owing to network failure, acceptor node failure, high network latency between the acceptor node and the proposer node or high latency within the acceptor node); or, 2) to vote against a state change in reliance on ultimately incorrect information (e.g., an acceptor votes “no” because of a competing state change that it has a record of when in fact it has yet to receive notice that the state change has been negated)

If the proposer 501_1 finds that a quorum exists the proposer broadcasts to each of the acceptor nodes 501_1 through 501_M that the requested state change has been approved. The acceptor nodes 501_1 through 501_M then update their respective local persistence store 503_1 through 503_M to reflect that the requested state change has been approved on the particular meta data item. In various embodiments, versioning numbers are assigned to state change requests to keep track of different requests that may simultaneously exist for a same meta data item. As such, the version number of the request that has just been approved is recorded in the local persistence store along with the identity of the meta data item and the fact that a state change request for it has been approved.

Any acceptor node that voted “no” for the request because its local persistence store showed the existence of a competing request (e.g., having an earlier version number) should expect to receive in the near future an indication that the prior competing request has been negated. If so, the acceptor's local store will eventually be updated to synchronize with the other acceptor nodes. If the expected notice does not arrive in sufficient or expected time, the acceptor node can raise an error.

In FIG. 5, each of the meta data duster nodes 501_1 through 501_M are depicted as including consensus algorithm logic 505_1 through 505_M to implement the aforementioned consensus algorithm meta data consistency mechanism. The logic 505_1 through 505_5 may be implemented as any combination of hardware and software. The meta data storage 507 may include its own (e.g., fast/flat) indexing or search tree technology and may also be implemented as a proprietary or publicly available cloud database or storage platform. In one implementation, the LeveldB cloud based key-value database technology from Google, Inc. is used for meta data storage 507.

Processes taught by the discussion above may be performed with program code such as machine-executable instructions which cause a machine (such as a “virtual machine”, a general-purpose CPU processor disposed on a semiconductor chip or special-purpose processor disposed on a semiconductor chip) to perform certain functions. Alternatively, these functions may be performed by specific hardware components that contain hardwired logic for performing the functions, or by any combination of programmed computer components and custom hardware components.

A storage medium may be used to store program code. A storage medium that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

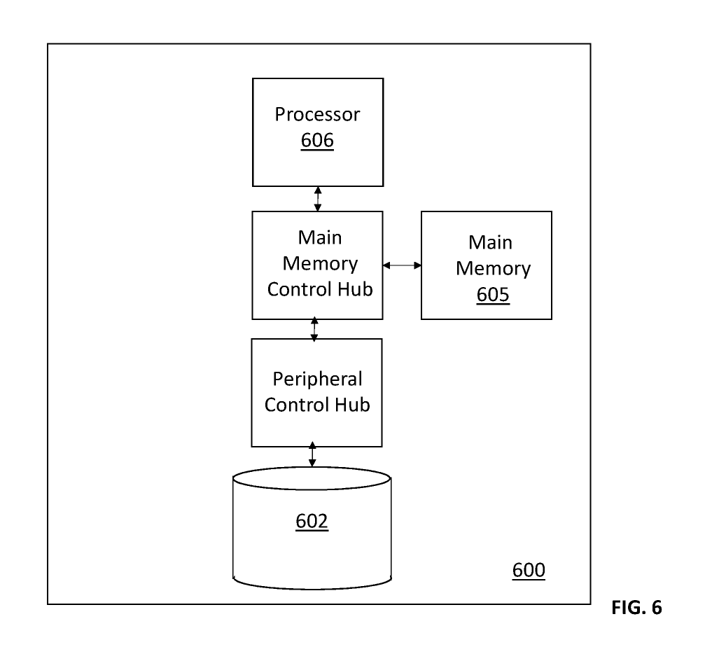

FIG. 6 is a block diagram of a computing system 600 that can execute program code stored by a storage medium. It is important to recognize that the computing system block diagram of FIG. 6 is just one of various computing system architectures. Different types of computing systems include mobile and/or handheld computing devices (e.g., smartphones, cell-phones, personal digital assistances), laptop personal computers, desktop personal computers, servers, etc.

The applicable storage medium may include one or more fixed components (such as non volatile storage component 602 (e.g., a hard disk drive, FLASH drive or non volatile memory) or main (system) memory 605) and/or various movable components such as a CD ROM, a compact disc, a magnetic tape, etc. operable with removable media drive. In order to execute the program code, typically instructions of the program code are loaded into the main Random Access Memory (RAM) system memory 605; and, a processor 606 then executes the instructions. The processing core 606 may include one or more CPU processors or CPU processing cores.

It is believed that processes taught by the discussion above can be described within various source code software environments such as, for example, object-oriented and/or non-object-oriented programming environments including but not limited to: C+/C++, PYTHON, Java, Erlang, JavaScript, etc. The source code can be subsequently compiled into intermediate code for translation on a translator/virtual machine, or, compiled into object code targeted for a specific processor instruction set architecture.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
receiving a request to search meta data for objects stored within a large scale object storage system, said request identifying a looked for value of the meta data, said objects belonging to a same bucket used to identify a subset of objects stored by the large scale object storage system;
forwarding said request to a meta data database system that contains pages listing all objects within the bucket and the associated meta data for each of the objects within the bucket; and,
forwarding the pages from said meta data database system over a network to a high performance computing resource that concurrently processes multiple ones of the pages to identify matching ones of the objects whose meta data matches the looked for value.

2. The method of claim 1 further comprising:
the high performance computing resource generating object identifiers of the matching objects;
accessing the matching objects from the object storage system using the object identifiers; and,
providing the matching objects to a requestor who issued the request.

3. The method of claim 2 wherein at least one of the object storage system, meta data database and the high performance computing resource are implemented with a cloud service.

4. The method of claim 1 further comprising:
the high performance computing resource generating names of the matching objects found in their respective meta data; and,
providing the names to a requestor who issued the request.

5. The method of claim 4 wherein at least one of the object storage system, meta data database and the high performance computing resource are implemented with a cloud service.

6. The method of claim 1 further comprising compressing the pages for transportation over the network.

7. The method of claim 1 wherein the meta data database uses a consensus algorithm to handle state changes to the meta data database.

8. One or more computer readable storage media containing program code that when processed by one or more computing systems cause the one or more computing systems to perform a method, comprising:
receiving a request to search meta data for objects stored within a large scale object storage system, said request identifying a looked for value of the meta data, said objects belonging to a same bucket used to identify a subset of objects stored by the large scale object storage system;
forwarding said request to a meta data database system that contains pages listing all objects within the bucket and the associated meta data for each of the objects within the bucket; and,
causing the pages to be forwarded from said meta data database system over a network to a high performance computing resource that concurrently processes multiple ones of the pages to identify matching ones of the objects whose meta data matches the looked for value.

9. The one or more computer readable storage media of claim 8 where the method further comprises:
receiving from the high performance computing resource object identifiers of the matching objects;
accessing the matching objects from the object storage system using the object identifiers; and,
providing the matching objects to a requestor who issued the request.

10. The one or more computer readable storage media of claim 9 wherein at least one of the object storage system, meta data database and the high performance computing resource are implemented with a cloud service.

11. The one or more computer readable storage media of claim 8 where the method further comprises:
receiving from the high performance computing resource names of the matching objects found in their respective meta data; and,
providing the names to a requestor who issued the request.

12. The one or more computer readable storage media of claim 11 wherein at least one of the object storage system, meta data database and the high performance computing resource are implemented with a cloud service.

13. The one or more computer readable storage media of claim 8 wherein the method further comprises compressing the pages for transportation over the network.

14. One or more computers collectively comprising a plurality of processors coupled to respective main memory and computer readable storage media, the computer readable storage media collectively containing program code that when processed by the plurality of processors from their respective main memory causes a method to be performed, comprising:
receiving a request to search meta data for objects stored within a large scale object storage system, said request identifying a looked for value of the meta data, said objects belonging to a same bucket used to identify a subset of objects stored by the large scale object storage system;
forwarding said request to a meta data database system that contains pages listing all objects within the bucket and the associated meta data for each of the objects within the bucket; and,
forwarding the pages from said meta data database system over a network to a high performance computing resource that concurrently processes multiple ones of the pages to identify matching ones of the objects whose meta data matches the looked for value.

15. The one or more computers of claim 14 wherein the method further comprises:
the high performance computing resource generating object identifiers of the matching objects;
accessing the matching objects from the object storage system using the object identifiers; and,
providing the matching objects to a requestor who issued the request.

16. The one or more computers of claim 15 wherein at least one of the object storage system, meta data database and the high performance computing resource are implemented with a cloud service.

17. The one or more computers of claim 14 further comprising:
the high performance computing resource generating names of the matching objects found in their respective meta data; and,
providing the names to a requestor who issued the request.

18. The one or more computers of claim 17 wherein at least one of the object storage system, meta data database and the high performance computing resource are implemented with a cloud service.

19. The one or more computers of claim 14 wherein the method further comprises compressing the pages for transportation over the network.

20. The one or more computers of claim 14 wherein the meta data database uses a consensus algorithm to handle state changes to the meta data database.
